(19) United States
(12) Patent Application Publication
(10) Pub. No.: US 2008/0136061 A1
(43) Pub. Date: Jun. 12, 2008

(54) Method of Processing Polycarbonate with Supercritical Fluids

(76) Inventors: Robert W. Peterson, Spring Valley, WI (US); James K. Young, Austin, TX (US)

Correspondence Address: 3M INNOVATIVE PROPERTIES COMPANY, PO BOX 33427, ST. PAUL, MN, 55133-3427, US

(21) Appl. No.: 11/815,628

(22) PCT Filed: Jan. 27, 2006
(86) PCT No.: PCT/US06/02991

§ 371 Date: Aug. 6, 2007

Related U.S. Application Data
(60) Provisional application No. 60/652,449, filed on Feb. 11, 2005.

(51) Int. Cl. B29C 45/57; B29C 45/17

(52) U.S. Cl. 264/328.16

(57) ABSTRACT

A method for forming shaped parts from polycarbonate that results in parts having substantially increased chemical resistance. The method includes providing a mold having at least one cavity, such that the mold has a means for cooling the area adjacent to the cavity. Molten polycarbonate is then mixed with a supercritical fluid to form a mixture. This mixture is injected into the mold while using the cooling means to cool the cavity so that its temperature is no more than 150 degrees F. Further improvement in chemical resistance is achieved when fluid pressure is held on the cooling part for a short period.

### TECHNICAL FIELD

The present disclosure relates to injection molding, and more particularly to the forming of polycarbonate compounds in the presence of a supercritical fluid.

### BACKGROUND

Polycarbonates, such as, for example, bisphenol A carbonate, are excellent engineering grade thermoplastics for many purposes. Such compounds tend to have high strength, stiffness, and toughness over a wide temperature range. They can be colored, compounded, and thermally formed in a variety of melt forming processes such as thermoforming, extrusion, compression and injection molding. The most often noted disadvantages to their use are limited chemical resistance, susceptibility to stress cracking, and notch sensitivity. In particular, polycarbonate compounds tend to have poor resistance to benzene, toluene, chlorinated hydrocarbons, heptane, ethyl acetate, and strong acids and bases. The ester linkage that connects the monomer units in a polycarbonate compound is hydrolysable, which renders the molecule susceptible to attack by hot water.

It is known to attempt to optimize the chemical resistance of the surface of a polycarbonate article when shaping by, for example, injection molding by operating running the mold at a substantially greater temperature than would be used for other injection moldable polymers. For example, the art teaches that injection molds for polycarbonate should be operated at least 180° F., and 200° F. and higher is more typical. Although the use of higher mold temperature increases mold cycle time undesirably, the chemical resistance does increase, presumably by reducing the amount of locked in stress adjacent to the surface of the finished part. The art would be greatly benefited by a method of shaping polycarbonate compounds that would further improve its chemical resistance, desirably without unduly increasing mold cycle time. Polycarbonate is also known to be able to exhibit semi-crystalline features, when prepared by slow evaporation from solvent or by long term heating at 180° C. While this morphology tends to increase resistance to chemical attack, the optical clarity of the polycarbonate decreases. Increasing chemical resistance of polycarbonate without introducing crystalline morphology is also desirable.

### SUMMARY OF THE DISCLOSURE

The present disclosure provides a process for shaping polycarbonate that results in parts having substantially greater chemical resistance than traditional processes. The process uses startlingly low mold temperatures, but uses them in concert with the introduction of supercritical fluid into the molten polycarbonate before it reaches the mold. Further, it has been discovered that maintaining pressure on the cooling part for a period of time further increases the chemical resistance.

In one aspect, the disclosure may be thought as a method for forming shaped parts from polycarbonate. Following the method includes providing a mold having at least one cavity, such that the mold has a means for precisely controlling the surfaces of the mold core and cavity in contact with injected polymer. Then molten polycarbonate is mixed with a supercritical fluid to form a mixture. This mixture is injected into the mold while using the cooling means to cool the cavity so that its temperature is no more than 150 degrees F.

### BRIEF DESCRIPTION OF THE DRAWING

In the several figures of the attached drawing, like parts bear like reference numerals, and:

FIG. 1 illustrates a supercritical fluid injection system;

FIG. 2 illustrates a molded plastic part prepared in a control and an experimental version to test the parameters of the present disclosure;

FIG. 3 illustrates the internal morphology of the part illustrated in FIG. 1 after processing according to the method of Example 2;

FIG. 4a illustrates the fracture of a control part prepared according to conventional molding techniques; and

FIG. 4b illustrates the fracture of an experimental part prepared according to the method of the present disclosure.

### DETAILED DESCRIPTION

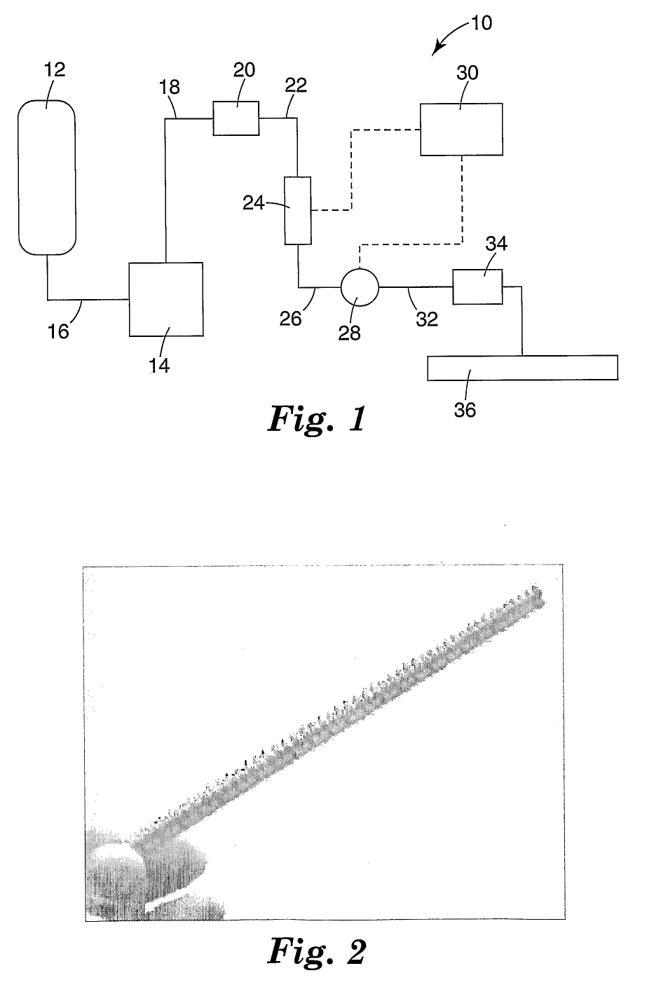

Referring now to FIG. 1, a block diagram of an exemplary super-critical fluid injection system suitable for carrying out the method of the present disclosure is illustrated. The injection system 10 includes a gas supply tank 12 feeding a gas pump 14 via conduit 16. Gas is pumped at high pressure up through conduit 18 to a pre-metering regulator 20. The regulated gas supply is delivered through conduit 22 to an electronically controllable metering valve 24 and from there via conduit 26 to a flow meter 28. A feedback loop mediated by a PID controller 30 between the flowmeter 28 back to the metering valve 24 ensures that the proper weight percent of gas is delivered. The metered flow is directed through conduit 32 and through post-metering pressure regulator 34 to the barrel of a conventional molding extruder 36.

### EXAMPLE 1

An injection mold was prepared as a single cavity cold runner mold, shaped so as to form the part illustrated in FIG. 2. The illustrated part was physically similar in all dimensional respects to a telephonic wire connector commercially available as 710 Index Strip from 3M Company of St. Paul, Minn. The molding machine was adapted so as to be able to inject supercritical nitrogen fluid into the molten polymer as a processing adjunct.

An injection molding run was performed with the mold, with polycarbonate resin commercially available as Bayer Makrolon 6555 from Miles Polymers Division of Pittsburg, Pa., being used as the polymer being molded. The mold was fed by a reciprocating single-screw type extruder, commercially available from Guelph, of Ontario, Calif., which was operated at a pressure of 2600 psi (17.9 MPa) in 18 second molding cycles. The mold was supplied with cooling fluid at 50 degrees F. These parts served as control samples in the experiment of Example 3 below.

### EXAMPLE 2

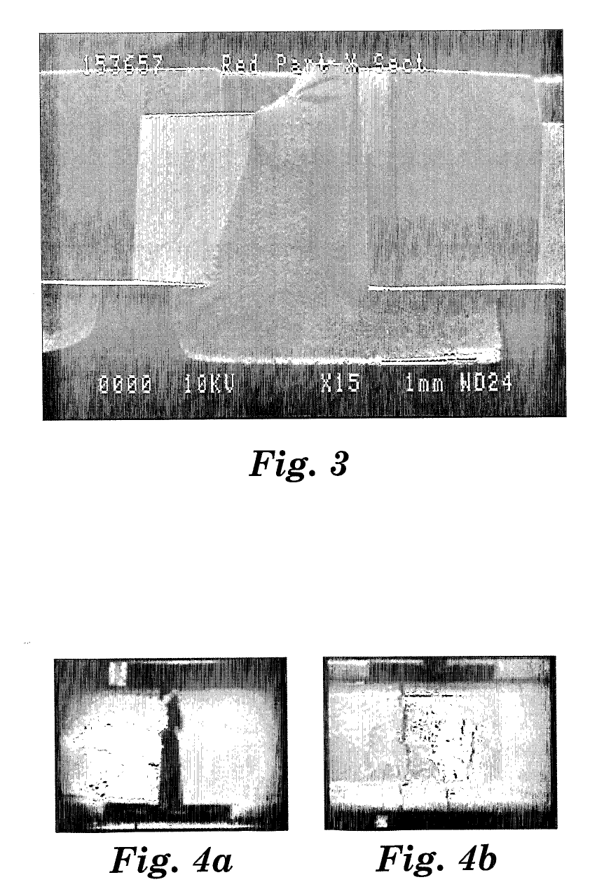

Plastic parts were fabricated as described in example 1, except for the following particulars. Supercritical nitrogen was melt mixed into the molten polycarbonate to the extent of 0.3 percent nitrogen, and the molding cycle time was 13.8 seconds. Compared to the process of example 1, about 5% less raw material was processed per cycle, the parts having a solid skin layer with a cellular core. The internal morphology of the parts produced according to this example is illustrated in the micrograph of FIG. 3. These parts served as experimental samples in the experiment of Example 3 below.

### EXAMPLE 3

A three point bending device was prepared, with the support points being 3 inches (7.62 cm) apart, and otherwise dimensionally convenient for the holding of the parts produced in examples 1 and 2. Parts according to examples 1 and 2 were placed into the bending device and a displacement of 0.015 inch (0.38 mm) strain from the horizontal was induced. While maintaining this strain, the parts were placed into a heptane/ethylacetate mixture (2:1 by weight), and a timer was used to identify when a crack visible to the naked eye first formed for each sample. Ten samples prepared according to example 1 had a mean time to crack formation of 28 seconds. Ten samples prepared according to example 2 had a mean time to crack formation of 164 seconds. This result indicates that the use of supercritical fluid can act to improve the chemical resistance in polycarbonate. It was noted that the type of fracture presented by the control and the experimental parts were quite different. FIG. 4a illustrates the fracture of the control part prepared according to Example 1, and FIG. 4b illustrates the fracture of the experimental part prepared according to Example 2.

### EXAMPLE 4

An injection mold was prepared as a four-cavity hot runner mold, shaped so as to form telephonic wire connector commercially available as the DPM-Body Top component from 3M Company of St. Paul, Minn. The mold was adapted so as to be able to inject supercritical nitrogen fluid into the molten polymer as a processing adjunct. A designed experiment of twenty-four injection molding runs were performed with the mold, with polycarbonate resin commercially available as Bayer Makrolon 2658 from Miles Polymers Division of Pittsburg, Pa. being used as the polymer being molded. The tenth part produced in each run was tested in the fixture and according to the protocol of Example 3, and the time to crack appearance according to that test is reported in the Table 1 below.

TABLE 1

| | | | | | Time to |
|---|---|---|---|---|---|
| | Hold | Hold | Cooling | Weight | crack |
| Run | pressure | time | time | % supercritical | appearance |
| number | (psi) | (seconds) | (seconds) | fluid | (seconds) |
| 1 | 1800 | 0.7 | 6 | 0.3 | 20.7 |
| 2 | 2600 | 0.2 | 8 | 0.1 | 15.7 |
| 3 | 2600 | 1.2 | 4 | 0.5 | 20.9 |
| 4 | 1000 | 0.2 | 8 | 0.5 | 14.7 |
| 5 | 1000 | 1.2 | 4 | 0.1 | 21.1 |
| 6 | 1800 | 0.7 | 6 | 0.3 | 23.6 |
| 7 | 1800 | 0.7 | 6 | 0.3 | 21.8 |
| 8 | 2600 | 0.2 | 4 | 0.5 | 10.6 |
| 9 | 1000 | 1.2 | 8 | 0.5 | 23.3 |
| 10 | 1000 | 0.2 | 4 | 0.1 | 14.4 |
| 11 | 1800 | 0.7 | 6 | 0.3 | 25.0 |
| 12 | 2600 | 1.2 | 8 | 0.1 | 21.9 |
| 13 | 2600 | 1.2 | 8 | 0.5 | 20.8 |
| 14 | 1000 | 0.2 | 4 | 0.5 | 12.2 |
| 15 | 1800 | 0.7 | 6 | 0.3 | 12.9 |
| 16 | 1800 | 0.7 | 6 | 0.3 | 13.7 |
| 17 | 2600 | 0.2 | 4 | 0.1 | 14.0 |
| 18 | 1000 | 1.2 | 8 | 0.1 | 16.9 |
| 19 | 1000 | 0.2 | 8 | 0.1 | 22.2 |
| 20 | 1800 | 0.7 | 6 | 0.3 | 24.0 |
| 21 | 2600 | 0.2 | 8 | 0.5 | 17.8 |
| 22 | 1800 | 0.7 | 6 | 0.3 | 17.5 |
| 23 | 1000 | 1.2 | 4 | 0.5 | 17.8 |
| 24 | 2600 | 1.2 | 4 | 0.1 | 87.2 |

### It was noted that run number 24 had a time to crack appearance that was noticeably greater than the other runs.

### EXAMPLE 5

A designed experiment was performed to follow up on the particularly noteworthy improvement in chemical resistance revealed in run 24 above. The four-cavity hot runner mold used in Example 4 was used to injection mold parts from polycarbonate resin commercially available as Bayer Makrolon 2658 from Miles Polymers Division of Pittsburg, Pa. The pressure during the hold was 2600 psi (17.9 MPa). Supercritical nitrogen was added in the amount of 0.1 weight percent, and once again the tenth part produced in each run was tested in the fixture and according to the protocol of Example 3, and the time to crack appearance according to that test is reported in Table 2 below.

TABLE 2

| | | Mold | Hold | Time to |
|---|---|---|---|---|
| | Polymer | cooling | pressure | crack |
| Run | melt temp. | fluid | time | appearance |
| number | (° F.) | temp. (° F.) | (seconds) | (seconds) |
| 1a | 615 | 125 | 0.8 | 67.5 |
| 2a | 625 | 125 | 1.2 | 48.5 |
| 3a | 620 | 120 | 1.0 | 35.0 |
| 4a | 615 | 125 | 1.2 | 66.4 |
| 5a | 615 | 115 | 1.2 | 141.8 |
| 6a | 625 | 125 | 0.8 | 20.4 |
| 7a | 625 | 115 | 1.2 | 34.8 |
| 8a | 625 | 115 | 0.8 | 21.4 |
| 9a | 620 | 120 | 1.0 | 38.6 |
| 10a | 620 | 120 | 1.0 | 33.3 |
| 11a | 615 | 115 | 0.8 | 42.9 |

Lower processing temperatures and longer hold pressures are associated with optimum chemical resistance. It should be noted that the mold cooling fluid temperature was not able to be lowered due to limitations in the mold hot manifold design.

Various modifications and alterations of the present disclosure will be apparent to those skilled in the art without departing from the scope and spirit of this disclosure, and it should be understood that this disclosure is not limited to the illustrative embodiments set forth herein. The claims follow.

1. A method for forming shaped parts from polycarbonate, comprising:
providing a mold having at least one cavity therein, the mold having a means for cooling the area adjacent to the cavity;
mixing molten polycarbonate with a supercritical fluid to form a mixture; and
injecting a mixture into the mold while using the cooling means to cool the cavity so that its temperature is no more than 150 degrees F.

2. The method according to claim 1 wherein the cooling means is used to cool the cavity so that its temperature is no more than 130 degrees F.

3. The method according to claim 2 wherein the cooling means is used to cool the cavity so that its temperature is no more than 90 degrees F.

4. The method according to claim 3 wherein the cooling means is used to cool the cavity so that its temperature is no more than 60 degrees F.

5. The method according to claim 1 wherein elevated pressure is held on the mixture in the mold for a period of at least 0.8 seconds.

6. The method according to claim 5 wherein elevated pressure is held on the mixture in the mold for a period of at least 1.0 seconds.

7. The method according to claim 6 wherein elevated pressure is held on the mixture in the mold for a period of at least 1.2 seconds.
